(19) United States
(12) Patent Application Publication
(10) Pub. No.: US 2026/0113674 A1
(43) Pub. Date: Apr. 23, 2026

(54) NETWORK HANDOVER FROM A PRIMARY CELL TO A SECONDARY CELL

(71) Applicant: RAKUTEN SYMPHONY, INC., Tokyo (JP)

(72) Inventors: Gugan ILANGOVAN, Karnataka (IN); Raghul SUNDARAVARADHAN, Karnataka (IN)

(73) Assignee: RAKUTEN SYMPHONY, INC., Tokyo (JP)

(21) Appl. No.: 19/257,630

(22) Filed: Jul. 2, 2025

(30) Foreign Application Priority Data
Oct. 18, 2024 (IN) 202411079341

(51) Int. Cl. H04W 36/00; H04W 36/08; H04W 36/30

(52) U.S. Cl. CPC H04W 36/0085; H04W 36/08; H04W 36/30

(57) ABSTRACT

Embodiments of the disclosure describe a method (400) for performing a handover from a primary cell (PCell) to one of one or more SCells. The method includes configuring (402), for a User Equipment (UE), an A1 event for the one or more Secondary Cells (SCells) associated with the UE and an eNodeB (eNB) or a gNodeB (gNB) in a network. The method includes receiving (404), from the UE, an A1 measurement report for each of the one or more SCells based on the configured A1 event. The method further includes performing (406) the handover from the PCell to the one or more SCells based on the received A1 measurement report.

### CROSS-REFERENCE TO RELATED APPLICATION(S)

This application claims priority to Indian non-provisional patent application 202411079341, filed on Oct. 18, 2024, the entire contents of which are incorporated herein by reference.

### FIELD

The present disclosure relates to a network handover procedure from a primary cell to a secondary cell.

### BACKGROUND

The information disclosed in this background section is only for enhancement of understanding of the general background of the disclosure and should not be taken as an acknowledgement or any form of suggestion that this information forms the prior art already known to a person skilled in the art.

In the existing telecommunication systems (e.g., 4G, 5G New Radio (NR) architecture, and 6G), a base station (gNodeB) (gNB) or an evolved Node B (eNB), manages one or more cells, including a Primary Cell (PCell) and one or more Secondary Cells (SCells), to support a user equipment (UE) via carrier aggregation for enhanced data transmission. A crucial function of the gNB or the eNB is to ensure seamless handover (HO) between the one or more cells when the UE moves or when signal quality degrades. An inter frequency HO process is managed through various inter-frequency events, such as an A3 event, an A4 event, and an A5 event, which monitor and report signal strength between the PCell, neighbouring cells, and SCells. Particularly, the A3 event is triggered when a neighbouring cell's signal becomes better by an offset value. The A4 event is triggered when the neighbouring cell's signal exceeds a predefined threshold, and the A5 event is triggered when the PCell's signal falls below one predefined threshold while a neighbour's signal surpasses another predefined threshold.

Further, in the existing techniques, the problem arises because the A4 event, used for handovers based on the neighbouring cell performance, does not consider the one or more SCells as part of the handover decision. In the A4 event, the neighbouring cell is understood as a cell that is neither the PCell nor a SCell. As a result, the UE is unable to trigger the A4 event for the one or more SCells, limiting the network's ability to initiate a threshold-based handover to the SCell.

In contrast, the A3 event and the A5 events include the PCell and the one or more SCells in the comparison, allowing handovers between the PCell and the one or more SCells based on these events, but not based on the A4 event, which is a simpler threshold-based handover mechanism. Consequently, this creates a gap in the handover process, where the gNB or eNB cannot use the A4 event to trigger a handover to the SCell even if the SCell's signal is better than a neighbouring cell's threshold. In particular, this behaviour has been observed in commercial UEs, leading to inefficiencies in managing handovers between the PCell and the one or more SCells, particularly when relying on the neighbour threshold-based triggers such as the A4 event.

FIG. 1 illustrates exemplary sequence flow diagrams that illustrate one or more operations involved in executing the handover request, according to prior art.

Referring to FIG. 1 for the handover request process, various entities are involved including the base station 102, the cell-1 104a, the cell-2 104b, and the UE 106 to manage seamless connectivity as the UE 106 moves between the cells (the cell-1 104a, the cell-2 104b) or experiences changes in signal quality. The base station 102 may be at least one of the gNB or eNB, managing the cell-1 104a and the cell-2 104b. The cell-1 104a may correspond to the PCell and the cell-2 104b may correspond to the neighbouring cell.

At operation 108, the UE 106 is initially connected to the cell-1 104a, which serves as the PCell. Thus, the UE's 106 primary communication with the network is managed by the cell-1 104a, which is controlled by the base station 102 (gNB or eNB).

At operation 110, the base station 102 configures the A2 event on the UE 106. The A2 event is triggered when the signal quality of the serving cell or the PCell (i.e., the cell-1 104a) falls below the predefined threshold. The A2 event is crucial for detecting when the connection to the cell-1 104a is deteriorating, thus prompting the UE 106 to start evaluating the other neighbouring cells.

At operation 112, once the A2 event is triggered the UE 106 sends an A2 measurement report back to the cell-1 104a. Thus, the A2 measurement report is sent upon the UE 106 determining that the signal quality of the cell-1 104a is below the predefined threshold. The A2 report indicates that the signal quality of the serving cell (the cell-1 104a) has degraded, potentially necessitating a handover to another cell.

At operation 114, after receiving the A2 report, the cell-1 104a reconfigures the UE 106. The cell-1 104a removes the A2 event and configures the A1 event for evaluating the PCell along with the A3 event, the A4 event, and the A5 event. The A3 event, the A4 event, and the A5 event allow the UE 106 to compare the neighbouring cells to the serving cell (the cell-1 104a). For instance, the A3 event compares the neighbouring cell to the serving cell or the PCell (the cell-1 104a) and triggers when the neighbour's signal becomes better than the PCell. The A4 event triggers when the neighbouring cell's signal becomes better than the predefined threshold. The A5 event triggers when the PCell's signal drops below a first predefined threshold and the neighbouring cell's signal exceeds a second predefined threshold. Consequently, the cell-2 104b (the neighbouring cell) becomes visible to the UE 106, and the UE 106 may begin evaluating whether the cell-2 104b meets the A3 event, the A4 event, or the A5 event trigger conditions.

At operation 116, once the cell-2 104b becomes visible and matches the A3 event, the A4 event, or the A5 event trigger conditions, the UE 106 sends a corresponding A3 measurement report, a corresponding A4 measurement report, or a corresponding A5 measurement report to the cell-1 104a. The corresponding A3 measurement report, the corresponding A4 measurement report, or the corresponding A5 measurement report contains details about the signal strength and quality of the cell-2 104b, indicating that the cell-2 104b may be a better candidate for handover than the cell-1 104a.

At operation 116, after processing the corresponding A3 measurement report, the corresponding A4 measurement report, or the corresponding A5 measurement report, the cell-1 104a initiates the handover process. The cell-1 104a processes the handover request and transfers the network connection from the cell-1 104a (the PCell) to the cell-2 104b (the neighbouring cell). Thus, ensuring that the UE 106 is handed over to a cell with better signal quality, maintaining optimal communication without service interruption.

Therefore, the handover process is finalized when the cell-1 104a decides that the cell-2 104b provides better signal quality and initiates the transfer of the UE's 106 network connection. Therefore, the one or more operations of the handover process ensure that the UE 106 seamlessly transitions between the one or more cells, maintaining strong signal quality and uninterrupted service, particularly as it moves across different areas managed by the network.

Thus, in FIG. 1, the issue persists that the A4 event, typically used for the handover based on the neighbouring cell performance, does not consider the cell-2 104b if it is the SCell, in the handover decision. Instead, the cell-2 104b is treated as the serving cell if it is the SCell thus, preventing the UE 106 from triggering the A4 event for the SCell.

FIG. 2 illustrates exemplary sequence flow diagrams that illustrate one or more operations involved in executing the handover request with the limitation of the A4 event, according to prior art.

Referring to FIG. 2 for the handover request process, various entities are involved including the base station 102, the cell-1 104a, the cell-2 104b, the cell-3 104c and the UE 106, to manage seamless connectivity as the UE 106 moves between the cells (the cell-1 104a, the cell-2 104b, 104c) or experiences changes in signal quality. The base station 102 may be at least one of the gNB, the eNB managing the cell-1 104a, the cell-2 104b, and the cell-3 104c. The cell-1 104a may correspond to the PCell.

At operation 202, initially, the UE 106 establishes an attachment to the cell-1 104a, which serves as the PCell. Simultaneously, the cell-2 104b is added as the SCell to enhance data throughput through carrier aggregation. The PCell manages the main control signalling, while the SCell provides additional bandwidth for data transmission.

At operation 204, the network via the cell-1 104a configures the A2 event on the UE 106. The A2 event is used to detect when the signal quality of the PCell (i.e., the cell-1 104a) drops below the predefined threshold, which triggers the UE 106 to start evaluating other cells for the handover. Thus, ensuring that when the cell-1 104a deteriorates, the UE 106 may begin seeking better candidate cells.

At operation 206, after the A2 event is triggered i.e., when the signal quality of the cell-1 104a falls below the predefined threshold, the UE 106 sends the A2 measurement report back to the cell-1 104a. The A2 measurement report confirms that the PCell's (i.e., the cell-1 104a) signal quality has degraded, and the handover may be required to maintain service quality.

At operation 208, the cell-1 104a, in response to the A2 measurement report, configures the A1 event and the A4 event for the UE 106. The A1 event monitors when the signal strength of the serving cell e.g., the PCell improves beyond the predefined threshold. Further, the A4 event allows the UE 106 to monitor neighbouring cells and triggers when the neighbouring cell's signal strength becomes better than the predefined threshold. Additionally, the cell-1 104a removes the A2 event configuration because the UE 106 may have sufficient information to begin evaluating the neighbouring cells through the A4 event for the handover.

At operation 210, the UE 106 sends the A4 measurement report based on the cell-3 104c (the neighbouring cell). The A4 measurement report indicates that the cell-3 104c has met a criteria associated with the A4 event i.e., the signal quality of the cell-3 104c is better than the predefined threshold. Thus, making the cell-3 104c a candidate for the handover.

At operation 212, the handover request is processed, however, the existing technique illustrates the limitation. Even though the cell-2 104b (i.e., the SCell) might meet the criteria associated with the A4 event, such as the signal quality of the cell-2 104b is higher than the predefined threshold, the A4 event does not apply to the cell-2 104b (the SCell) because the one or more SCells are treated as serving cells and not as the neighbouring cells. The A4 event only evaluates the neighbouring cells that are not part of the serving cells i.e., cells that are not PCell or the SCell.

Consequently, even if the cell-2 104b meets the criteria associated with the A4 event, the UE 106 may not trigger the A4 event for the cell-2 104b, because it is considered part of the serving cell group, not the neighboring cell. Therefore, the A4 event cannot be used to initiate the handover to the cell-2 104b, even though it might provide a better signal quality.

Thus, the limitation in the existing techniques prevents the network from triggering handover to the one or more SCells based on the criteria or conditions of the A4 event. Therefore, highlighting the need for alternative techniques to handle such scenarios.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to one embodiment of the present disclosure, a method for processing a handover is disclosed. The method includes configuring, for a User Equipment (UE), an A1 event for one or more Secondary Cells (SCells) associated with the UE and an eNodeB (eNB) or a gNodeB (gNB) in a network. The method further includes receiving, from the UE, an A1 measurement report for each of the one or more SCells based on the configured A1 event. The method furthermore includes performing the Handover (HO) from a primary cell (PCell) to one of the one or more SCells based on the received A1 measurement report from one of the one or more SCells.

According to one embodiment of the present disclosure, an apparatus is implemented at a base station. The apparatus configures, for a User Equipment (UE), an A1 event for one or more Secondary Cells (SCells) associated with the UE and the apparatus. The apparatus is further configured to receive, from the UE, an A1 measurement report for each of the one or more SCells based on the configured A1 event. The apparatus is further configured to perform the handover (HO) from a Primary Cell (PCell) to one of the one or more SCells based on the received A1 measurement report from one of the one or more SCells.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates exemplary sequence flow diagrams that illustrate one or more operations involved in executing the handover request, according to prior art;

FIG. 2 illustrates exemplary sequence flow diagrams that illustrate one or more operations involved in executing the handover request with the limitation of the A4 event, according to prior art;

FIG. 3 illustrates exemplary sequence flow diagrams that illustrate one or more operations involved in executing an A1 event based handover request from a primary cell to a secondary cell, according to an embodiment as disclosed herein;

FIG. 4 is a flow diagram illustrating a method for executing the A1 event based handover process from the primary cell to the secondary cell, according to an embodiment as disclosed herein; and

FIG. 5 illustrates a diagram of example components of an apparatus, according to an embodiment as disclosed herein.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

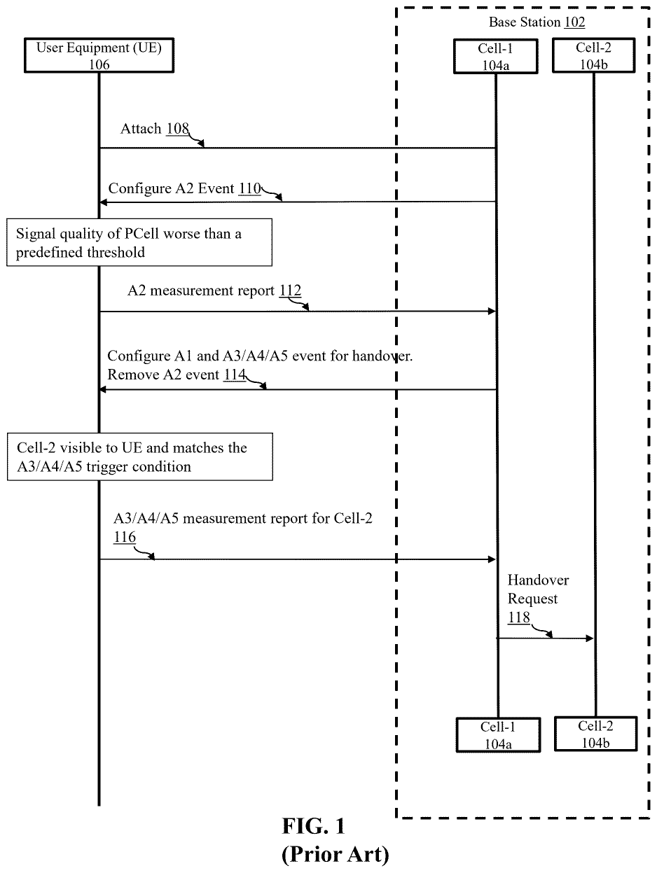

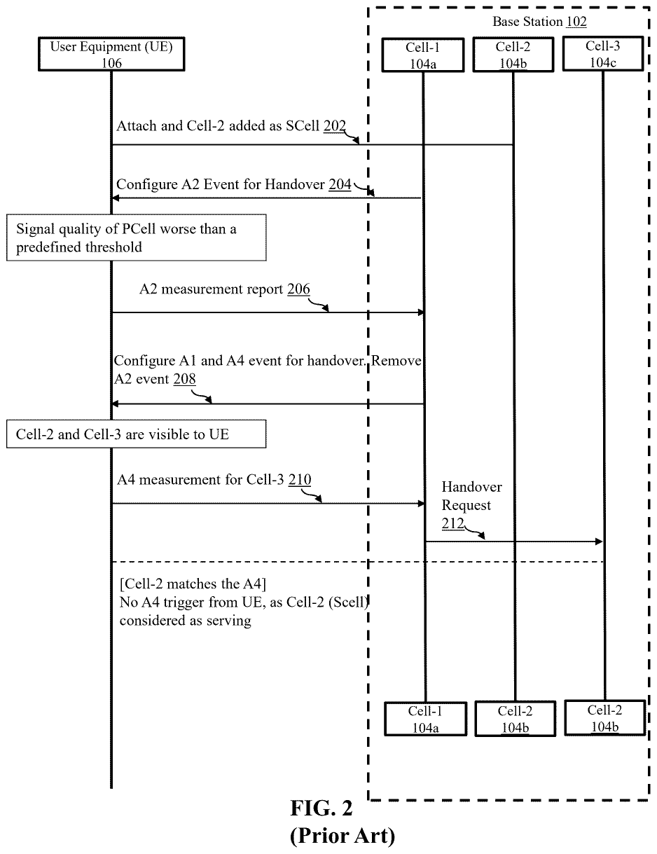

In the existing telecommunication systems, as illustrated in FIG. 1 and FIG. 2, that the A4 event, typically used for the handover based on the neighbouring cell performance, does not consider one or more SCells in the handover decision. Instead, the one or more Scells are treated as serving cells, thus preventing a user equipment (UE) from triggering the A4 event for the one or more SCells. The present disclosure provides a solution which involves triggering the handover to the one or more SCells.

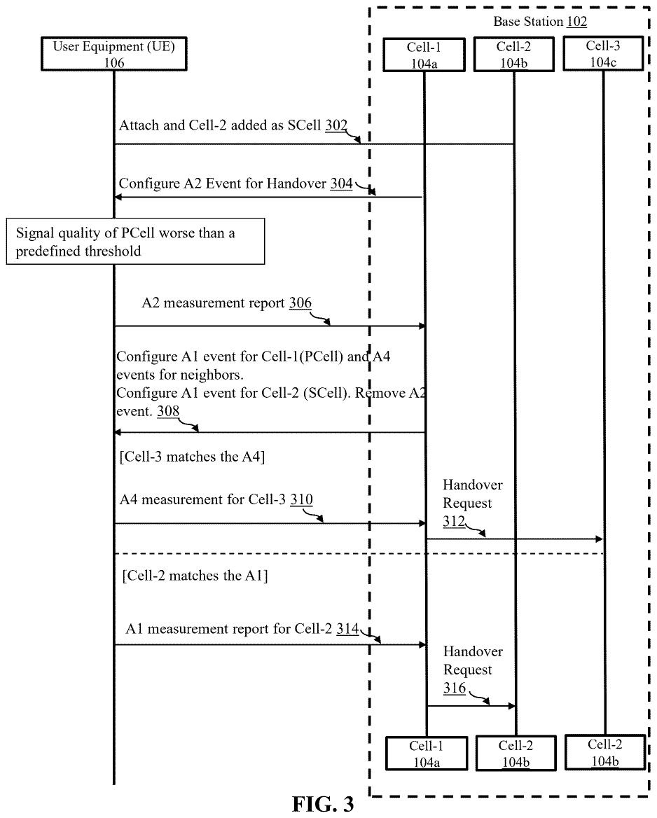

FIG. 3 illustrates exemplary sequence flow diagrams that illustrate one or more operations involved in executing an A1 event based handover request from a primary cell to a secondary cell, according to an embodiment as disclosed herein.

Referring to FIG. 3 for the handover request process, various entities are involved including the base station 102, the cell-1 104a, the cell-2 104b, the cell-3 104c and the UE 106, to manage seamless connectivity as the UE 106 moves between the cells (the cell-1 104a, the cell-2 104b, 104c) or experiences changes in signal quality. The base station 102 may be at least one of a Next-Generation Node B (gNB), an Enhanced Node B (eNB) managing the cell-1 104a, the cell-2 104b, and the cell-3 104c. The cell-1 104a may correspond to a primary cell (PCell).

In an embodiment, at operation 302, initially, the UE 106 establishes a connection or attaches to the cell-1 104a, designated as the primary cell (PCell). Alongside this, the cell-2 104b is added as the secondary Cell (SCell) to increase the data capacity and bandwidth through carrier aggregation. The PCell handles the primary communication and control, while the SCell supplements the connection for data transmission.

At operation 304, an A2 event is configured by the cell-1 104a on the UE 106. The A2 event is triggered when the signal quality of the PCell (i.e., the cell-1 104a) falls below a predefined threshold.

In an embodiment, the A2 event refers to a measurement event used in LTE and 5G NR networks, triggered when the signal quality of a serving cell such as the primary cell the UE 106 is connected to falls below the predefined threshold. The A2 event is typically configured by the network to monitor the quality of the connection between the UE 106 and the PCell for the handover. The A2 event is configured to detect when the signal quality of the serving cell has degraded to a point that could negatively affect the user experience.

The serving cell refers to the cell in the telecom communication network such as LTE or 5G NR that currently provides the primary radio connection for the UE 106. The serving cell is responsible for managing the communication between the UE 106 and the network, facilitating data transmission, and receiving control information.

Further, the A2 event helps the network to decide if the handover to another cell is required. In the A2 event the signal quality is measured using metrics like the Reference Signal Received Power (RSRP), Reference Signal Received Quality (RSRQ), or Signal to Interference plus Noise Ratio (SINR). Furthermore, the A2 event is triggered when the signal strength or quality of the serving cell drops below the predefined threshold set by the network. The predefined threshold is typically set to ensure that handover decisions are made before the signal deteriorates to an unusable level. Once the A2 event is triggered, the UE 106 sends an A2 measurement report back to the serving cell for instance, the PCell, notifying the network that the signal has dropped below the predefined threshold. The network may then decide to initiate the handover process to another cell with better signal quality.

Furthermore, the A2 event signals that the quality of the connection between the UE 106 and the cell-1 104a is deteriorating and that the handover process should begin to transfer the UE 106 to a better cell.

At operation 306, once the A2 event is triggered from the PCell, the UE 106 sends the A2 measurement report to the cell-1 104a. The A2 measurement report indicates that the signal quality of the cell-1 104a (PCell) is below the predefined threshold. Advantageously, the A2 measurement report provides information to the network for further decision-making regarding handover.

At operation 308, the cell-1 104a configures the events on the UE 106 in response to the A2 measurement report.

In an embodiment, the A1 event is configured for the cell-1 104a (PCell) to monitor when its signal improves beyond the predefined threshold. The A4 event is configured for the neighbouring cells to track if the signal strength associated with the neighbouring cells exceeds the predefined threshold and accordingly designate them as potential candidates for handover. Further, the A1 event is also configured for the cell-2 104b (i.e., the SCell), to monitor if the signal strength associated with the cell-2 104b improves beyond the predefined threshold. The one or more SCells are part of the serving cells and are not considered as the neighbouring cells.

The configuration of the A1 event for the one or more SCells associated with the UE 106 refers to the process of configuring the A1 event for the cell-2 104b, which is the SCell in FIG. 3.

In an embodiment, the A1 event corresponds to a measurement event used by the UE 106 to monitor the signal strength of the serving cell i.e., the cell-2 104b (the SCell). The A1 event is triggered when the signal strength of the serving cell improves and exceeds the predefined threshold set by the network. Thus, the A1 event is used to track if the SCell (the cell-2 104b) has the signal strength strong enough to be considered a good candidate for continued or enhanced service. Further, the cell-2 104b, as the Secondary Cell (SCell), is an additional serving cell that the UE 106 may connect to, typically in carrier aggregation scenarios where multiple cells work together to provide better performance. Thus, based on configuring the A1 event for the SCell, the network is instructing the UE 106 to monitor whether the signal from the SCell (the cell-2 104b) improves beyond a certain level (i.e., the predefined threshold). Advantageously, the configuration of the A1 event for the cell-2 104b (SCell) is to assess whether the signal quality of the SCell becomes good enough to support communication for the UE 106. Thus, if the SCell's signal strength improves beyond the predefined threshold, it indicates that the SCell is capable of handling the UE's connection, allowing the network to consider the handover to the SCell.

Furthermore, once the A1 event is triggered, i.e., the signal strength of the SCell has improved, the UE 106 sends the A1 measurement report back to the network. Based on the A1 measurement report, the network may decide to initiate the handover from the PCell i.e., the cell-1 104a to the SCell i.e., the cell-2 104b, or to start utilizing the SCell for better performance, such as offloading traffic or improving data throughput.

In an embodiment, the predefined threshold corresponds to the signal strength level set by the network. If the signal strength of the SCell exceeds the predefined threshold, it signals to the network that the SCell's conditions have improved enough to support the UE's 106 communication requirements. The predefined threshold helps the network maintain high-quality service by ensuring that handovers or cell switching only occur when the SCell's signal is strong enough.

Furthermore, the A2 event is removed post indicating that the cell-1's 104a signal has degraded. The A2 event removal may indicate that the UE 106 no longer monitors the signal quality of the cell-1 104a for the A2 event. The removal of the A2 event is typically done because the network is now aware of the degraded signal and may need to take further actions, such as initiating the handover process. Advantageously, removing the A2 event allows the network to reconfigure the UE 106 for different measurement events such as the A1 event, the A3 event, or the A4 event that may be more relevant for the next steps in managing the UE's 106 connection. For instance, the network might configure the UE 106 to monitor the neighbouring cells for potential handover opportunities or to focus on the performance of the SCell that may provide better service. Thus, the A2 event removal aims to maintain a high-quality connection for the UE 106 ensuring that the UE 106 is not wasting resources monitoring the serving cell that is already known to have poor performance.

At operation 310, Based on the A4 event, the UE 106 sends an A4 measurement report to the cell-1 104a for the cell-3 104c, as the neighbouring cell. The A4 measurement report indicates that the cell-3 104c meets a criteria associated with the A4 event criteria for instance, the signal is better than the predefined threshold, making the cell-3 104c a candidate for handover.

In an embodiment, at operation 312, based on the A4 measurement, the cell-1 104a may initiate the handover process from the cell-1 104a to the cell-3 104c, if the cell-3 104c exceeds the predefined threshold and conditions are favourable for the handover.

At operation 314, in addition to the A4 process for the cell-3 104c (neighbouring cell), the A1 event is configured for the cell-2 104b (SCell). Accordingly, if the cell-2 104b matches the A1 event criteria i.e., the cell-2's 104b signal strength exceeds the predefined threshold, the UE 106 sends the A1 measurement report to the Cell-1 104a. The A1 measurement report indicates that the SCell (i.e., the cell-2 104b) has a sufficiently strong signal to be considered for handover.

In an embodiment, at operation 316, the base station 102 initiates the handover from the cell-1 104a (PCell) to the cell-2 104b (SCell) based on the A1 measurement report for the cell-2 104b. Advantageously, the A1 events are configured to track the serving cells (for instance the SCell) rather than the neighbouring cells.

In an embodiment, the A1 event works similarly to the A4 event, where A4 is used for handover decisions based on the neighbouring cells, and the A1 event is used for the handover decisions based on the SCell.

In an embodiment, the A1 measurement report includes key signal quality parameters such as Reference Signal Received Power (RSRP), Reference Signal Received Quality (RSRQ), and Signal to Interference and Noise Ratio (SINR) for SCells. The A1 measurement report helps determine whether the SCell (the cell-2 104b) has a strong enough signal to warrant the handover from the PCell.

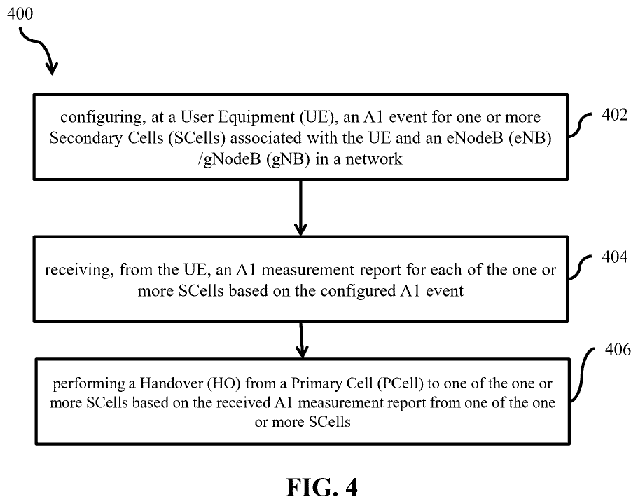

FIG. 4 is a flow diagram illustrating a method 400 for executing the A1 event based handover process from the primary cell to the secondary cell, according to an embodiment as disclosed herein. The method 400 may be performed by the base station 102 as discussed throughout the disclosure.

At step 402, the method 400 may include configuring, for the UE 106, the A1 event for the one or more SCells associated with the UE 106 and the base station 102 in the network as discussed in Para [0046-0052].

At step 404, the method 400 may include receiving, from the UE 106, the A1 measurement report for each of the one or more SCells based on the configured A1 event as discussed in Para [0055].

At step 406, the method 400 may include performing a Handover (HO) from a Primary Cell (PCell) to one of the one or more SCells based on the received A1 measurement report from one of the one or more SCells as discussed in Para [0056-0058].

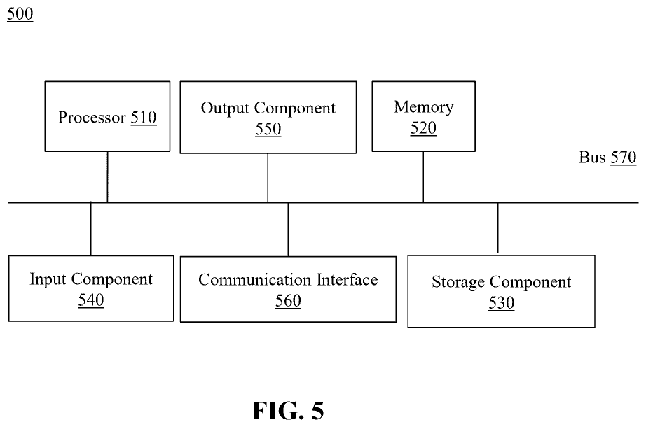

FIG. 5 illustrates a diagram of example components of an apparatus 500, according to an embodiment as disclosed herein. As shown in FIG. 5, the apparatus 500 comprises a processor 510, a memory 520, a storage component 530, an input component 540, an output component 550, a communication interface 560, and a bus 570. In one embodiment, the apparatus 500 may correspond to the base station 102 (i.e., gNB or the eNB), or any other network device.

The processor 510, as used herein, means any type of computational circuit that may comprise hardware elements and software elements. The processor 510 may be embodied as a multi-core processor, a single core processor, or a combination of one or more multi-core processors and/or one or more single core processors, a distributed processing system, or the like. The processor 510 may be a Central Processing Unit (CPU), a graphics processing unit (GPU), an accelerated processing unit (APU), an application-specific integrated circuit (ASIC), or another type of processing component.

The memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 cause the processor 510 to perform one or more method steps of an embodiment described above.

The storage component 530 stores information and/or software related to the operation and use of the apparatus 500. For example, the storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

The output component 550 is configured to provide output information from the system 700. For example, the output component 550 may be, but is not limited to, a display, a speaker, instructions to an external device, and/or one or more light-emitting diodes (LEDs).

The communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the apparatus 500 and other devices. In other words, the standard of the communication interface 560 is not limited.

The bus 570 acts as an interconnect between the processor 510, the memory 520, the storage component 530, the input component 540, the output component 550, and the communication interface 560 of the apparatus 500. The bus 570 may include a wired interconnection or a wireless interconnection.

The number and arrangement of components shown in FIG. 5 are provided as an example. In practice, the apparatus 500 may include additional components, fewer components, different components, or differently arranged components than those shown in FIG. 5. Additionally, or alternatively, a set of components (e.g., one or more components) of the apparatus may perform one or more functions described as being performed by another set of components of the apparatus 500. Further, one or more method steps described in any of the embodiments may be performed utilizing the apparatus 500 in communication with one another.

The various actions, acts, blocks, steps, or the like in the flow diagrams or sequence flow diagrams may be performed in the order presented, in a different order, or simultaneously. Further, in some embodiments, some of the actions, acts, blocks, steps, or the like may be omitted, added, modified, skipped, or the like without departing from the scope of the present disclosure.

The disclosed method 400 has several advantages over the existing telecommunication systems, for example, which are stated below,
a. The present disclosure enables the network to continuously monitor the signal strength of these SCells based on configuring the A1 event for the SCells. This allows the UE to report when the signal quality of the one or more SCells has improved beyond the predefined threshold, ensuring that handover decisions are based on real-time and accurate information.
b. The present disclosure allows the network to efficiently utilize the SCells in a carrier aggregation scenario. Thus, instead of relying solely on the PCell, the network can offload traffic or fully switch the UE's connection to the SCell, optimizing the overall use of the available spectrum and improving network efficiency.
c. The present disclosure provides a smoother and more seamless user experience by enabling the handover from the PCell to an SCell based on the A1 measurement reports. Thus, reducing the likelihood of service interruptions or degraded quality during the handover process, and enhancing the continuity of service for the UE.
d. The present disclosure adds an option for triggering handovers, apart from existing inter-frequency events like the A3 event, the A4 event, and the A5 event. Therefore, providing network operators greater flexibility in managing the UE's connection, especially in complex multi-cell environments.
e. The present disclosure actively monitors the SCells for improved signal strength, ensuring that the handover to the SCell occurs when the SCell can provide better performance compared to the PCell. Thereby making the UE's connection more adaptable and capable of maintaining high-quality service as conditions change.
f. The present disclosure reduced the load on the PCell.

Examples of the techniques and apparatus described herein include, but are not limited to, the following enumerated embodiments:

[1] An apparatus configured to:
configure, for a User Equipment (UE), an A1 event for one or more Secondary Cells (SCells) associated with the UE and the apparatus;
receive, from the UE, an A1 measurement report for each of the one or more SCells based on the configured A1 event; and
perform a Handover (HO) from a Primary Cell (PCell) to one of the one or more SCells based on the received A1 measurement report from one of the one or more SCells.

[2] The apparatus as described in [1], wherein prior to configuration of the A1 event for the one or more SCells, the apparatus is configured to:
configure, for the UE, an A2 event for the PCell associated with the UE.

[3] The apparatus as described in any one of [1]-[2], wherein the A1 event for the one or more SCells, the apparatus is configured to:
receive, from the UE, an A2 measurement report based on the configured A2 event; and configure, for the UE, an A1 event for the PCell, A1 event for one or more SCells and an A4 event for one or more neighboring cells based on the received A2 measurement report.

[4] The apparatus as described in any one of [1]-[3], wherein prior to configuration of the A1 event for the one or more SCells, the apparatus is configured to remove the A2 event for the PCell.

[5] The apparatus as described in any one of [1]-[4], wherein the apparatus is configured to:
assign an identical threshold value for the A1 event and the A4 event.

[6] The apparatus as described in any one of [1]-[5], wherein each of the A1 event, the A2 event, and the A4 event corresponds to one or more HO events in a network.

[7] The apparatus as described in any one of [1]-[6], wherein the A1 measurement report comprises a Reference Signal Received Power (RSRP), a Reference Signal Received Quality (RSRQ), and a Signal to Interference and Noise Ratio (SINR) associated with the one or more SCells.

[8] The apparatus as described in any one of [1]-[7], wherein the apparatus corresponds to a base station in the network comprising the PCell and the one or more SCells.

[9] The apparatus as described in any one of [1]-[8], wherein the PCell and the one or more SCells are configured as one or more serving cells for the UE.

[10] A method comprising:
configuring, for a User Equipment (UE), an A1 event for one or more Secondary Cells (SCells) associated with the UE and the base station in a network;
receiving, from the UE, an A1 measurement report for each of the one or more SCells based on the configured A1 event; and
performing a Handover (HO) from a Primary Cell (PCell) to one of the one or more SCells based on the received A1 measurement report from one of the one or more SCells.

[11] The method as described in [10], wherein prior to configuring the A1 event for the one or more SCells, the method comprises:
configuring, for the UE, an A2 event for the PCell associated with the UE;
receiving, from the UE, an A2 measurement report based on the configured A2 event; and
configuring, for the UE, at least one of an A1 event for the PCell and an A4 event for one or more neighboring cells based on the received A2 measurement report.

[12] The method as described in any one of [10]-[11], wherein prior to configuring the A1 event for the one or more SCells, the method comprises removing the A2 event for the PCell.

[13] The method as described in any one of [10]-[12], wherein the method comprises:
assigning an identical threshold value for the A1 event and the A4 event.

[14] The method as described in any one of [10]-[13], wherein each of the A1 event, the A2 event, and the A4 event corresponds to one or more HO events in the network.

[15] The method as described in any one of [10]-[14], wherein the A1 measurement report comprises a Reference Signal Received Power (RSRP), a Reference Signal Received Quality (RSRQ), and a Signal to Interference and Noise Ratio (SINR) associated with the one or more SCells.

[16] The method as described in any one of [10]-[15], wherein the Pcell and the one or more SCells are configured as one or more serving cells for the UE.

[17] A non-transitory computer-readable medium storing instructions, the instructions comprising: one or more instructions that, when executed by a base station comprising one or more processors, cause the one or more processors to:
configure, for a User Equipment (UE), an A1 event for one or more Secondary Cells (SCells) associated with the UE and the eNB;
receive, from the UE, an A1 measurement report for each of the one or more SCells based on the configured A1 event; and
perform a Handover (HO) from a Primary Cell (PCell) to one of the one or more SCells based on the received A1 measurement report from one of the one or more SCells.

[18] The non-transitory computer-readable medium storing instructions as described in [17], wherein prior to configuration of the A1 event for the one or more SCells, the one or more processors is configured to remove an A2 event for the PCell.

[19] The non-transitory computer-readable medium storing instructions as described in any one of [17]-[18], wherein the one or more processors is configured to:
assign an identical threshold value for the A1 event and the A4 event.

[20] The non-transitory computer-readable medium storing instructions as described in any one of [17]-[19], wherein the A1 measurement report comprises a Reference Signal Received Power (RSRP), a Reference Signal Received Quality (RSRQ), and a Signal to Interference and Noise Ratio (SINR) associated with the one or more SCells.

The embodiments disclosed herein can be implemented through at least one software program running on at least one hardware device and performing network management functions to control the elements. The elements can be at least one of a hardware device or a combination of hardware devices and software modules.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We Claim:

1. An apparatus configured to:
configure, for a User Equipment (UE), an A1 event for one or more Secondary Cells (SCells) associated with the UE and the apparatus;
receive, from the UE, an A1 measurement report for each of the one or more SCells based on the configured A1 event; and
perform a Handover (HO) from a Primary Cell (PCell) to one of the one or more SCells based on the received A1 measurement report from one of the one or more SCells.

2. The apparatus of claim 1, wherein prior to configuration of the A1 event for the one or more SCells, the apparatus is configured to:
configure, for the UE, an A2 event for the PCell associated with the UE.

3. The apparatus of claim 1, wherein the A1 event for the one or more SCells, the apparatus is configured to:
receive, from the UE, an A2 measurement report based on the configured A2 event; and
configure, for the UE, an A1 event for the PCell, A1 event for one or more SCells and an A4 event for one or more neighboring cells based on the received A2 measurement report.

4. The apparatus of claim 2, wherein prior to configuration of the A1 event for the one or more SCells, the apparatus is configured to remove the A2 event for the PCell.

5. The apparatus of claim 1, wherein the apparatus is configured to:
assign an identical threshold value for the A1 event and the A4 event.

6. The apparatus of claim 3, wherein each of the A1 event, the A2 event, and the A4 event corresponds to one or more HO events in a network.

7. The apparatus of claim 1, wherein the A1 measurement report comprises a Reference Signal Received Power (RSRP), a Reference Signal Received Quality (RSRQ), and a Signal to Interference and Noise Ratio (SINR) associated with the one or more SCells.

8. The apparatus of claim 1, wherein the apparatus corresponds to a base station in the network comprising the PCell and the one or more SCells.

9. The apparatus of claim 1, wherein the PCell and the one or more SCells are configured as one or more serving cells for the UE.

10. A method comprising:
configuring, for a User Equipment (UE), an A1 event for one or more Secondary Cells (SCells) associated with the UE and a base station in a network;
receiving, from the UE, an A1 measurement report for each of the one or more SCells based on the configured A1 event; and
performing a Handover (HO) from a Primary Cell (PCell) to one of the one or more SCells based on the received A1 measurement report from one of the one or more SCells.

11. The method of claim 10, wherein prior to configuring the A1 event for the one or more SCells, the method comprises:
configuring, for the UE, an A2 event for the PCell associated with the UE;
receiving, from the UE, an A2 measurement report based on the configured A2 event; and
configuring, for the UE, at least one of an A1 event for the PCell and an A4 event for one or more neighboring cells based on the received A2 measurement report.

12. The method of claim 11, wherein prior to configuring the A1 event for the one or more SCells, the method comprises removing the A2 event for the PCell.

13. The method of claim 10, wherein the method comprises:
assigning an identical threshold value for the A1 event and the A4 event.

14. The method of claim 11, wherein each of the A1 event, the A2 event, and the A4 event corresponds to one or more HO events in the network.

15. The method of claim 10, wherein the A1 measurement report comprises a Reference Signal Received Power (RSRP), a Reference Signal Received Quality (RSRQ), and a Signal to Interference and Noise Ratio (SINR) associated with the one or more SCells.

16. The method of claim 10, wherein the Pcell and the one or more SCells are configured as one or more serving cells for the UE.

17. A non-transitory computer-readable medium storing instructions, the instructions comprising: one or more instructions that, when executed by a base station comprising one or more processors, cause the one or more processors to:
configure, for a User Equipment (UE), an A1 event for one or more Secondary Cells (SCells) associated with the UE and the base station;
receive, from the UE, an A1 measurement report for each of the one or more SCells based on the configured A1 event; and
perform a Handover (HO) from a Primary Cell (PCell) to one of the one or more SCells based on the received A1 measurement report from one of the one or more SCells.

18. The non-transitory computer-readable medium storing instructions of claim 17, wherein prior to configuration of the A1 event for the one or more SCells, the one or more processors is configured to remove an A2 event for the PCell.

19. The non-transitory computer-readable medium storing instructions of claim 17, wherein the one or more processors configured to:
assign an identical threshold value for the A1 event and the A4 event.

20. The non-transitory computer-readable medium storing instructions of claim 17, wherein the A1 measurement report comprises a Reference Signal Received Power (RSRP), a Reference Signal Received Quality (RSRQ), and a Signal to Interference and Noise Ratio (SINR) associated with the one or more SCells.
